(19) United States
(12) Patent Application Publication
(10) Pub. No.: US 2025/0389680 A1
(43) Pub. Date: Dec. 25, 2025

(54) Determining a Curing Profile of an Electrical Insulation Layer

(71) Applicant: Innomotics GmbH, Nürnberg (DE)

(72) Inventors: Bastian Plochmann, Neustadt an der Aisch (DE); Tobias Katzenberger, Bad Königshofen STT Untereßfeld (DE); Matthias Übler, Ursensollen (DE); Jürgen Huber, Erlangen (DE); Dieter Schirm, Breitengüßbach (DE)

(73) Assignee: Innomotics GmbH, Nürnberg (DE)

(21) Appl. No.: 18/881,349

(22) PCT Filed: Jun. 27, 2023
(86) PCT No.: PCT/EP2023/067383

§ 371 Date: Jan. 6, 2025

(30) Foreign Application Priority Data
Jul. 6, 2022 (EP) 22183330.4

(51) Int. Cl. G01N 25/48; H02K 15/122

(52) U.S. Cl. CPC G01N 25/4853; G01N 25/4826; H02K 15/122

(57) ABSTRACT

Various embodiments of the teachings herein include a method of ascertaining a progression of curing on application of an electrical insulation layer of an insulation material in a liquid state to an electrical product. An example includes: providing a temperature progression that the electrical product undergoes in the course of application and curing of the insulation layer; providing a reaction model of the insulation material to give a progression of curing of the insulation material on the basis of a temperature progression as input parameter and modeled on the basis of measured enthalpies of reaction of the insulation material at two different heating rates; and ascertaining the progression of curing using the reaction model with the temperature progression.

### CROSS-REFERENCE TO RELATED APPLICATIONS

This application is a U.S. National Stage Application of International Application No. PCT/EP2023/067383 filed Jun. 27, 2023, which designates the United States of America, and claims priority to EP Application Serial No. 22183330.4 filed Jul. 6, 2022, the contents of which are hereby incorporated by reference in their entirety.

### TECHNICAL FIELD

The present disclosure relates to curing of materials. Various embodiments of the teachings herein include systems and/or methods to determine a progression of curing, apply an electrical insulation layer of an insulation material in the liquid state, and apply the insulation material to an electrical product, e.g. an electrical winding system.

### BACKGROUND

Such a method is used, for example, in the impregnating of rotors and stators of electric motors. The impregnating operation which is often implemented in the form of an immersed impregnation and subsequent hot air oven curing is a major cost factor in manufacture with regard to capital costs, maintenance, cycle times, manufacturing space demand, etc. Optimization potentials can be found here firstly in material consumption, curing temperature/time (energy costs, CO₂), and in automation.

### SUMMARY

Teachings of the present disclosure may be used to improve the curing of the insulation material. For example, some embodiments include a method of ascertaining a progression of curing (C1, C2) on application of an electrical insulation layer of an insulation material (40) in the liquid state to an electrical product, especially to an electrical winding system (25), comprising: providing a temperature progression (TC) that the electrical product undergoes in the course of application and curing of the insulation layer, providing a reaction model of the insulation material that gives the progression of curing of the insulation material on the basis of a temperature progression as input parameter and is modeled on the basis of measured enthalpies of reaction (h1, . . . , h6) of the insulation material (40) at at least two, or at least four, different heating rates and ascertaining the progression of curing (C1, C2) by the reaction model with the temperature progression (TC).

In some embodiments, the measured enthalpies of reaction are measured by differential scanning calorimetry on the insulation material.

In some embodiments, the heating rates are in the range from 0.1 K/min to 10 K/min, especially in the range from 0.25 K/min to 8 K/min.

In some embodiments, the reaction model is modeled on the basis of measured enthalpies of reaction at at least four different heating rates.

In some embodiments, the reaction model is modeled by determining progressions of the reaction rates of curing on the basis of enthalpies of reaction of the insulation material, and curing progressions are determined by integrating the progressions of the reaction rates.

In some embodiments, the reaction model is modeled on the basis of the Arrhenius equation.

In some embodiments, the temperature progression (TC) is a measured temperature progression of an electrical product, especially a temperature progression measured with a thermocouple in an electrical winding system.

In some embodiments, the temperature progression (TC) is a target temperature progression of an electrical product.

In some embodiments, the ascertaining of the curing progression by the reaction model comprises ascertaining a gel point.

In some embodiments, the insulation material is a resin, e.g. a liquid reactive resin, especially epoxy resin, unsaturated polyester or polyesterimide.

As another example, some embodiments include a method of applying an electrical insulation layer of an insulation material (40) in the liquid state to an electrical product, e.g. to an electrical winding system (25), comprising: providing the electrical product, providing the insulation material ((40) in the liquid state, applying the insulation material (40) to the product, curing the insulation material (40), providing a temperature progression (TC) that the electrical product undergoes in the course of application and curing of the insulation layer, and ending the curing when a curing progression ascertained by a method as claimed in any of the preceding claims exceeds a threshold.

In some embodiments, the applying is an immersing of the electronic product into a bath of the insulation material (40) in the liquid state.

In some embodiments, the applying is a sprinkling of the electronic product with the insulation material (40) in the liquid state.

### BRIEF DESCRIPTION OF THE DRAWINGS

There follows a detailed description and elucidation of the teachings herein with reference to the working examples shown in the figures. The figures show:

FIG. 1 a schematic of a method of applying an insulation material to an electrical winding system,

FIG. 2 an illustrative temperature progression on application and curing,

FIG. 3 DSC measurements on an insulation material at different heating rates,

FIG. 4 reaction rates of the insulation material examined in FIG. 3, ascertained from the DSC measurements,

FIG. 5 reaction progresses integrated from the reaction rates,

FIG. 6 a schematic diagram of the reaction model for the insulation material, and

FIG. 7 a curing progression ascertained by means of one reaction model each for two different insulation materials.

### DETAILED DESCRIPTION

Some embodiments of the teachings herein include a method of ascertaining a progression of curing on application of an electrical insulation layer of an insulation material in the liquid state to an electrical product, e.g. to an electrical winding system. An example method includes: providing a temperature progression that the electrical product undergoes in the course of application and curing of the insulation layer, providing a reaction model of the insulation material that gives the progression of curing of the insulation material on the basis of a temperature progression as input parameter and is modeled on the basis of measured enthalpies of reaction of the insulation material at at least two, preferably at least four, different heating rates and ascertaining the progression of curing by the reaction model with the temperature progression.

The electrical winding system, as well as windings in electric motors, i.e. stators or rotors, may also relate to coils for further applications, e.g. magnetic field coils in magnetic resonance tomography or HF coils.

The progression of curing may be a progression, normalized to 1, based on a full enthalpy of curing of the respective insulation material and is plotted against time. The heating rates are temperature slopes that are used in the measurements. As a special case, it is also possible here to use heating rates of 0 K/min, i.e. isotherms.

The reaction model interpolates the enthalpies or reaction rates for temperature slopes other than the heating rates that were used in the measurements. For instance, the reaction model can give a progress of curing for all temperature slopes that occur in the course of application and curing. It is thus possible to ascertain a slope of temperature for each time step, which allows the reaction model to give a progress in the progression of curing.

In some embodiments, the measured enthalpies of reaction are measured by differential scanning calorimetry on the insulation material. It is thus only necessary to examine a few samples of the insulation material in order to parametrize the model. The DSC signals thus measured may be integrated to determine the enthalpy of reaction at the particular heating rate. On the basis of a full enthalpy of reaction that occurs in the case of full crosslinking of the insulation material, it is then possible to state a progression of reaction for the insulation material. In other words, complete crosslinking is the highest possible degree of crosslinking owing to the free reactants that are potentially present with involvement of steric hindrance (i.e. monomers that are redundant because of inability to diffuse and excessively large distances from potential reactants).

In some embodiments, the heating rates are in the range from 0.1 K/min to 10 K/min. In particular, heating rates in the range from 0.25 K/min to 8 K/min may be advantageous since coverage of the temperature slopes that typically occur in the course of curing is thus ensured.

In some embodiments, the reaction model is modeled on the basis of measured enthalpies of reaction at at least four different heating rates. In order to improve interpolation for enthalpies of reaction for temperature slopes other than the heating rates examined, it has been found to be advantageous to conduct measurements (e.g. DSC measurements) on the insulation material at at least four different heating rates.

In some embodiments, the reaction model is modeled by determining progressions of the reaction rates of curing on the basis of enthalpies of reaction of the insulation material. The reaction rate progressions can be ascertained here, for example, by normalizing the DSC signal to a full enthalpy of the curing reaction. In addition, the progressions of curing are determined by integrating the reaction rate progressions.

In some embodiments, the reaction model is modeled on the basis of the Arrhenius equation. It may be advantageous when a value which is variable over the progression of curing and not a constant is used for the activation energy EA in the Arrhenius equation.

In some embodiments, the temperature progression is a measured temperature progression of an electrical product, especially a temperature progression measured with a thermocouple in an electrical winding system. For instance, it is possible to provide a temperature progression easily and efficiently. It is often the case that the thermocouple can remain in the winding system after the insulation material has been applied. It would even be possible to follow the progression of curing in real time. It is often sufficient when the progression of curing is determined once for the respective insulation material and the electrical product if many different types of product are being manufactured.

In some embodiments, the temperature progression is a target temperature progression of an electrical product. The target temperature progression may be a temperature progression which is defined and observed in the system. For instance, it is possible to verify whether the temperature progression leads reliably to sufficient curing of the insulation material.

In some embodiments, ascertaining of the curing progression by the reaction model comprises ascertaining of a gel point. The gel point may be applied here to the progression of curing and be ascertained, for example, by rheological measurements. The gel point or else gelation point is characterized here by a defined increase in viscosity and can be ascertained by the crossing of storage modulus and loss modulus in the rheological measurements.

The insulation material thus already adheres better to the electrical product and no longer flows away. Correspondingly, subsequent steps (e.g. removal from the bath) can thus be timed more accurately. It is also possible that a viscosity threshold other than the gel point is defined, which has to be exceeded when the next process step is to be conducted.

In some embodiments, the insulation material is a resin, e.g. a liquid reactive resin, especially epoxy resin, unsaturated polyesters or polyesterimide. It is also possible to use the reaction model to determine curing progressions of multicomponent resins (e.g. aminically curing epoxy resins, polyurethanes with isocyanate) that are mixed onto the electrical product immediately before curing.

Another example includes a method of applying an electrical insulation layer of an insulation material in the liquid state to an electrical product, e.g. to an electrical winding system, comprising: providing the electrical product, providing the insulation material in the liquid state, applying the insulation material to the product, curing the insulation material, providing a temperature progression that the electrical product undergoes in the course of application and curing of the insulation layer, and ending the curing when a curing progression ascertained by a method as described herein exceeds a threshold.

Measuring the temperature progression by means of a thermocouple positioned in or on the electrical product may be performed but is generally not necessary for every product. The curing can be conducted with supply of external heating energy.

The threshold of the progression of curing, i.e. a degree of curing from which the curing can be ended, may be 80% for example. The ending of the curing is the ending of active curing with supply of external heating energy. The insulation material may then, for example, continue to cure fully in the product, for example under the influence of the remaining residual heat; it does not need to remain in the plant for this purpose.

In some embodiments, applying is an immersing of the electronic product into a bath of the insulation material in the liquid state. In the bath, the electrical product itself may be heated, for example by supplying power to the winding system.

In some embodiments, applying is a sprinkling of the electronic product with the insulation material in the liquid state. It may be sensible here to consider the temperature progression only over and above a certain amount of the insulation material that has been applied by sprinkling.

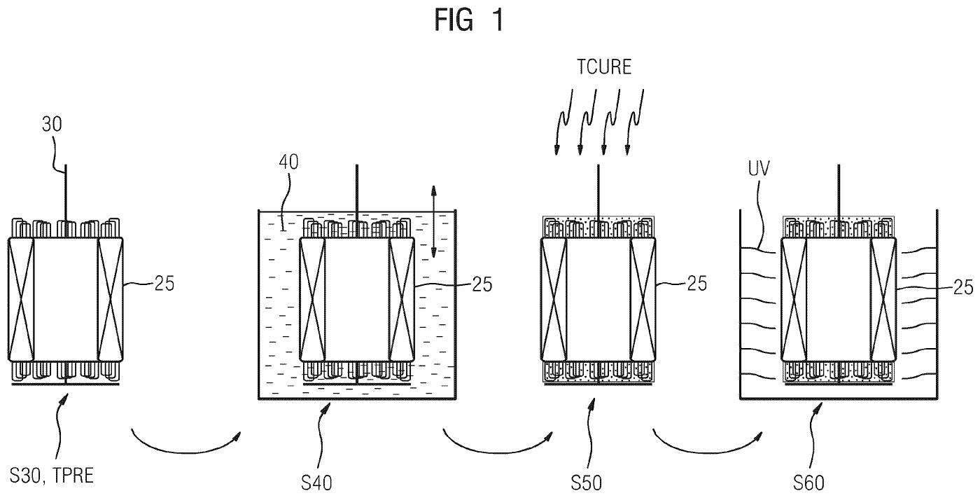

FIG. 1 shows a schematic diagram of a method of applying an insulation material 40 in the liquid state to an electrical winding system 25, in the form here of stator windings of an electric motor. The stator or winding system 25 is disposed here on a carrier 30 for transportation through a manufacturing plant.

Step S30 shows a schematic of preheating of the winding system 25 outside the insulation material with a temperature progression TPRE or to a temperature TPRE.

Step S40 shows immersion of the winding system into an immersion bath filled with liquid insulation material 40. On immersion, it is possible to continue to supply current to and heat the electrical winding system 25.

Step S50 shows curing of the insulation material 40 under the action of a temperature progression TCURE. This may be provided by an oven additionally or alternatively to supplying power to the winding system 25.

In step S60, UV curing is then conducted by UV radiation UV. This has the advantage that the insulation material thus cures well on the surface as well and is no longer tacky. UV curing is optional here.

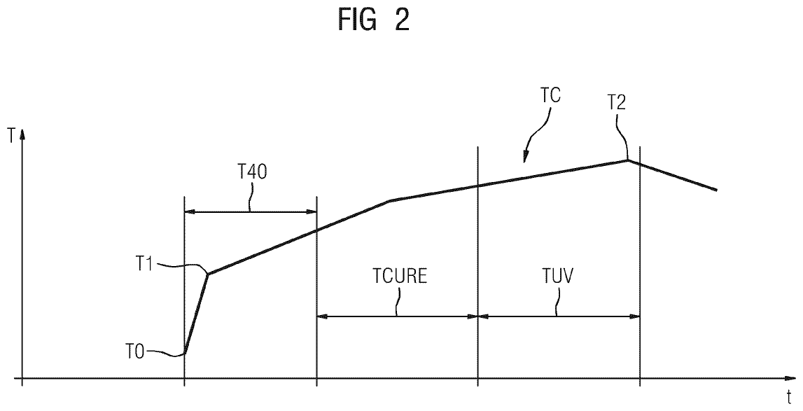

FIG. 2 shows, by way of example, a temperature progression TC on application and curing of an insulation material, for example as shown in FIG. 1, that the insulation material undergoes by way of approximation on the electrical product, for example on the winding system 25.

A first temperature TO is found from the temperature of the product on application of the liquid insulation material and the temperature of the insulation material on application. On immersion into the liquid insulation material 40, for example, the temperature TO is thus established. Heating up to the second temperature T1 may firstly result from thermal inertia of the electrical winding system, and secondly occur by additional heating of the winding system. The temperature progression T40 describes the progression that the resin undergoes directly on the product in the course of application. A further region shows the temperature progression TCURE on curing, for example in the oven. A final region TUV shows the temperature progression during UV curing that ensures high surface curing in particular, while the product is still being heated up to the final temperature T2. Thereafter, cooling occurs, and the insulation material continues to cure gradually.

It is then possible to ascertain a progression of curing for such a temperature profile TC even though there are different slopes that do not correspond to the heating rates.

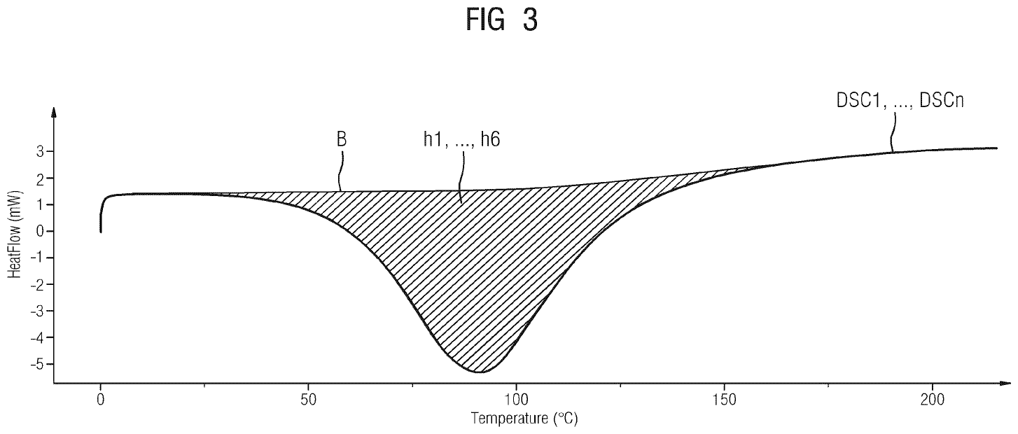

FIG. 3 shows DSC measurements (differential scanning calorimetry) on an insulation material at respectively different heating rates, in this case at 0.25 K/min, 0.5 K/min, 1 K/min, 2 K/min, 4 K/min and 8 K/min. A heat flow in mW is plotted here against temperature. The DSC measurement here compares mass of sample in a sample vessel filled with the insulation material used per unit standardized sample mass with an equivalent empty sample vessel, i.e. a differential in heat flow is shown.

Integration below a baseline B gives a specific enthalpy for the respective reactions. Such analyses can be conducted with conventional programs for DSC instruments.

Progressive enthalpy is a measure of the progress of the reaction, based in each case on one of the heating rates.

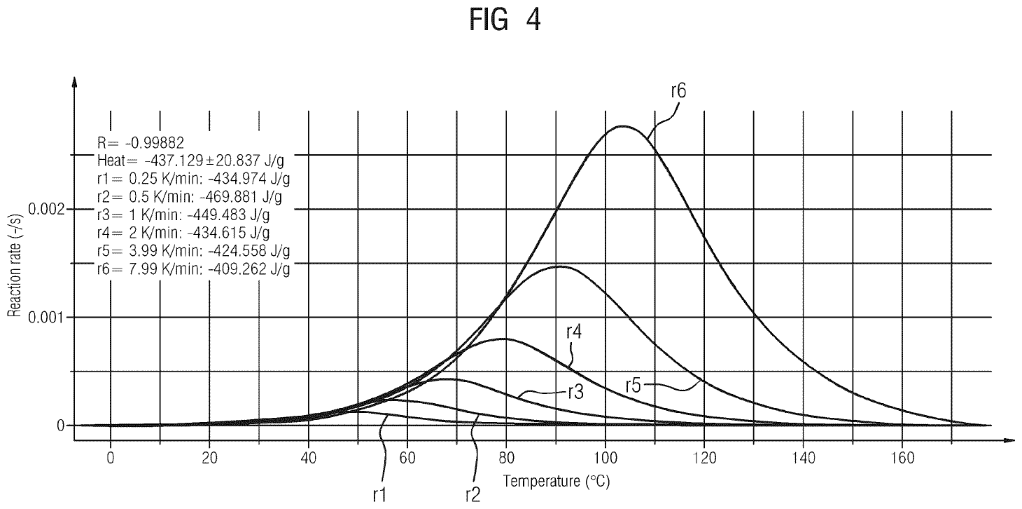

FIG. 4 shows, after correction of offset and plotted in the opposite direction, reaction rates r1, . . . , r6 ascertained from the DSC measurements in 1/s of the insulation material examined in FIG. 3, again plotted against temperature. The reaction rates r1, . . . , r6 are found from the enthalpy for the full reaction (including full enthalpy) and the currently ascertained enthalpy for the respective time, or temperature point here. The full enthalpy may be fixed, for example, in FIG. 3 such that no further change takes place here with regard to the baseline B.

Reaction rate r1 was ascertained here at a heating rate of 0.25 K/min, reaction rate r2 at 0.5 K/min, reaction rate r3 at 1 K/min, reaction rate r4 at 2 K/min, reaction rate r5 at 4 K/min and reaction rate r6 at 8 K/min. The heating rates here are merely illustrative and may be chosen in accordance with the insulation material used.

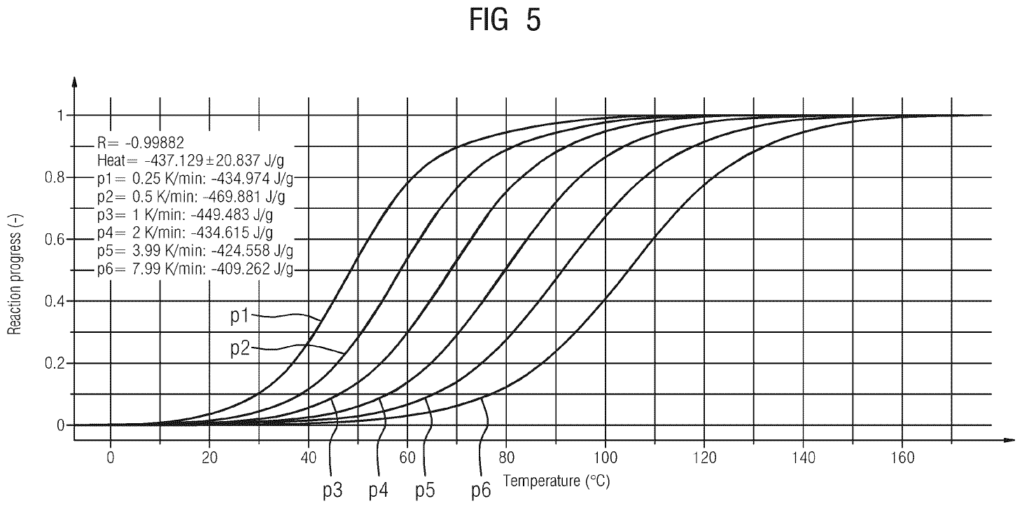

FIG. 5 shows reaction progresses integrated from the reaction rates, which can be ascertained by integration of the curves from FIG. 4. This gives rise to a reaction progress normalized to 1 in absolute terms against temperature. The reaction progress in this case is the degree of curing. The reaction progresses here are assigned analogously to FIG. 4 follows: reaction progress p1 was ascertained at a heating rate of 0.25 K/min, reaction progress p2 at 0.5 K/min, reaction progress p3 at 1 K/min, reaction progress p4 at 2 K/min, reaction progress p5 at 4 K/min and reaction progress p6 at 8 K/min.

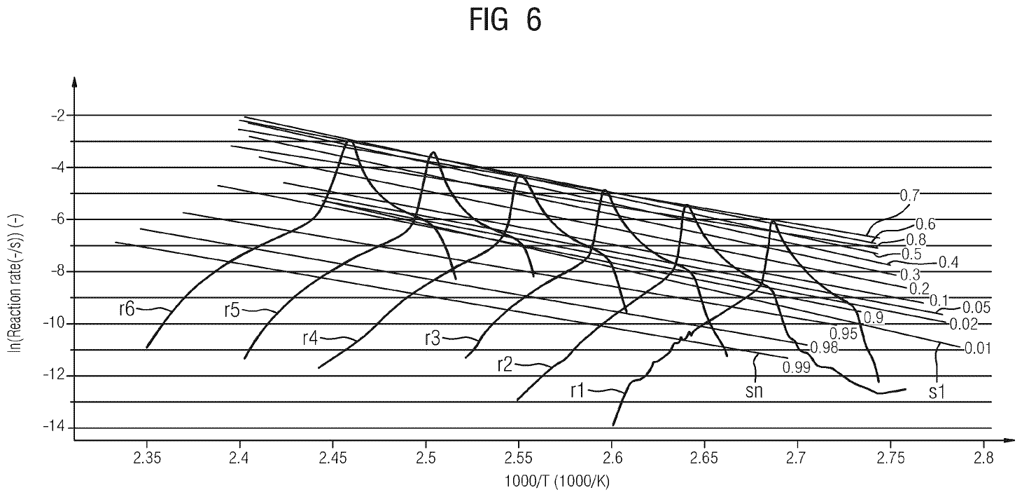

FIG. 6 then shows how the data shown in FIGS. 4 and 5 are converted to a model by an isoconversion analysis (also called isoconversional kinetic analysis), and the reaction progress or progression of curing are ascertained even for temperature changes that do not correspond to the heating rates.

Shown first of all, on a scale of 1000/temperature in 1000/K against ln of the reaction rate (1/s), are the reaction rates r1, . . . , r6, as shown in FIG. 4. But the actual reaction model is represented by the straight lines s1, . . . , sn, with modeling here by employing an approach based on the Arrhenius equation with variable activation energy. The model assumption here is that the curing reaction is affected solely by the temperature profile. UV curing the surface is not included in the model—but improves the surface quality of the insulation layer.

Isoconversion analysis can be conducted, for example, according to Friedman or Ozawa-Flynn-Wall. The activation energy values are fitted here by differential or integrating methods. Differential isoconversion methods are based on the Arrhenius equation.

The straight lines s1, . . . , sn each interpolate the reaction rates for one degree of curing, and hence the reaction parameters, for example the activation energy, for the ranges between the curves r1, . . . , r6. It has been found that it is thus possible to achieve a very high accuracy in ascertaining the progression of curing for heating rates or changes in temperature that were not examined.

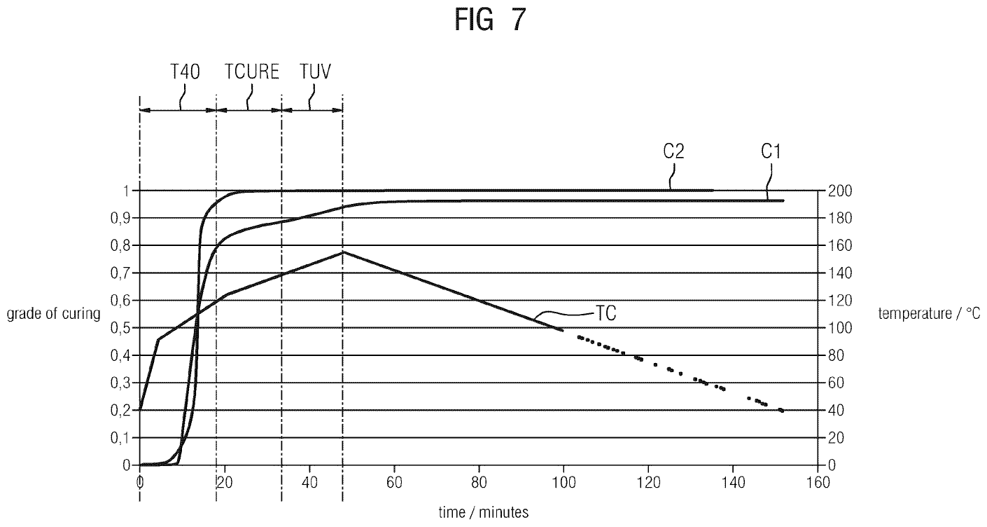

FIG. 7 shows a progression of curing ascertained by means of one reaction model each for two different insulation materials, with the same temperature progression TC. In the present case, a first, original insulation material (a resin) was cured with a first curing progression C1. It can be seen that there is no occurrence of complete curing in spite of long duration and high temperature. Another second insulation material, with the same temperature progression TC, can undergo a second curing progression C2 and is already fully cured at about half of the curing process in the region TCURE (for example in the oven). Accordingly, the second insulation material can be cured much more quickly and with low energy expenditure. Optimization of the temperature progression—for example shortening or with lower maximum temperature—would thus be advantageously possible.

### REFERENCE NUMERALS

25 electrical winding system
30 carrier
40 insulation material in the liquid state
S30 preheating
TPRE temperature progression of the preheating
S40 application of the insulation material
T40 temperature progression of the electrical product on application of the insulation material
S50 curing
TCURE temperature progression of the curing
S60 curing under UV
UV UV curing apparatus
TUV temperature progression on UV curing
TC temperature progression on application and curing
T0 first temperature
T1
DSC1, . . . , DSCn DSC signal
h1, . . . , hn specific enthalpy in J/g
r1, . . . , r6 reaction rate
p1, . . . , p6 degree of curing
C1, C2 progression of curing

What is claimed is:

1. A method of ascertaining a progression of curing on application of an electrical insulation layer of an insulation material in a liquid state to an electrical product, the method comprising:
providing a temperature progression that the electrical product undergoes in the course of application and curing of the insulation layer;
providing a reaction model of the insulation material to give a progression of curing of the insulation material on the basis of a temperature progression as input parameter and modeled on the basis of measured enthalpies of reaction of the insulation material at two different heating rates; and
ascertaining the progression of curing using the reaction model with the temperature progression.

2. The method as claimed in claim 1, wherein the measured enthalpies of reaction are measured by differential scanning calorimetry on the insulation material.

3. The method as claimed in claim 1, wherein the heating rates are in the range from 0.1 K/min to 10 K/min.

4. The method as claimed in claim 1, wherein the reaction model is modeled on the basis of measured enthalpies of reaction at at least four different heating rates.

5. The method as claimed in claim 1, wherein the reaction model is modeled by determining progressions of the reaction rates of curing on the basis of enthalpies of reaction of the insulation material, and curing progressions are determined by integrating the progressions of the reaction rates.

6. The method as claimed in an of claim 1, wherein the reaction model is modeled on the basis of the Arrhenius equation.

7. The method as claimed in claim 1, wherein the temperature progression is a measured temperature progression of an electrical product.

8. The method as claimed in claim 1, wherein the temperature progression is a target temperature progression of an electrical product.

9. The method as claimed in claim 1, wherein ascertaining of the curing progression comprises ascertaining a gel point.

10. The method as claimed in claim 1, wherein the insulation material comprises a resin.

11. A method of applying an electrical insulation layer of an insulation material in a liquid state to an electrical product, the method comprising:
applying the insulation material in the liquid state to the electrical product;
curing the insulation material;
providing a temperature progression that the electrical product undergoes in the course of application and curing of the insulation layer;
providing a reaction model of the insulation material to give a progression of curing of the insulation material on the basis of a temperature progression as input parameter and modeled the basis of measured enthalpies of reaction of the insulation material at two different heating rates;
ascertaining the progression of curing using the reaction model with the temperature progression; and
ending the curing when a curing progression ascertained exceeds a threshold.

12. The method as claimed in claim 11, wherein applying includes immersing the electronic product into a bath of the insulation material.

13. The method as claimed in claim 11, wherein applying includes sprinkling the electronic product with the insulation material in the liquid state.
